(19) United States
(12) Patent Application Publication
(10) Pub. No.: US 2015/0302769 A1
(43) Pub. Date: Oct. 22, 2015

(54) Virtual Hand-Washing Coach

(71) Applicant: Raymond C. Johnson, Creve Coeur, MO (US)

(72) Inventor: Raymond C. Johnson, Creve Coeur, MO (US)

(21) Appl. No.: 14/705,683

(22) Filed: May 6, 2015

Related U.S. Application Data
(63) Continuation of application No. PCT/US2013/068702, filed on Nov. 6, 2013.
(60) Provisional application No. 61/722,842, filed on Nov. 6, 2012.

(51) Int. Cl. G09B 19/00; G09B 5/06

(52) U.S. Cl. CPC G09B 19/0076; G09B 5/06

(57) ABSTRACT

An interactive monitoring system for arbitrarily complex hand-washing processes from simple hand-washing to full surgical scrub comprising user identification, multi-camera monitoring of hand-washing motions, various media for instructional or other feedback to the user, and a central computing system for storing hand-washing and instructional rules, instructional and other media, user-specific characteristics and rules and data on the status, quality and compliance of all hand-washing events monitored.

### CROSS-REFERENCE TO RELATED APPLICATIONS

This application incorporates by reference U.S. Pat. No. 6,038,331, issued Mar. 14, 2000, for Apparatus and Method for Monitoring Hand Washing, U.S. Pat. No. 6,970,574, issued Nov. 29, 2005, for Pattern Recognition System and Method for Monitoring Hand Washing or Application of a Disinfectant and U.S. Pat. No. 8,249,295, issued Aug. 21, 2012, for System for Monitoring Hand Cleaning Compliance. Also incorporated by reference is provisional application Ser. No. 13/311,101, filed Dec. 5, 2011, for Method for Monitoring Health Care Compliance, a copy of which is attached hereto.

### BACKGROUND

The importance of hand-washing to personal and public health is well-known and well documented. It is also standard practice in the medical field that hand hygiene that must be performed by a surgeon, for example, prior to performing surgery, using a procedure which is a much more complicated process than hand-washing as practiced by the general public. A surgeon will need to not only wash his/her hands, but to also specifically scrub each fingernail, scrub each part of the hand a prescribed number of times, wash arms as well as hands. There may also be a requirement that sleeves be rolled up to a certain point during the washing process, that fingernails are adequately trimmed, etc. There are other circumstances under which extended and more complicated hygiene practices are required for public health and safety.

A large number of inventions have attempted to provide a means of monitoring whether or not hand-washing is being performed and some of those attempt to determine the quality of the hand-washing. For example, Glenn et al in published application 2010/0326472, discloses a wash monitoring system for hands and/or other objects. The system actually performs the washing of a user's hands in an attempt to ensure that the hands are properly washed. The system identifies users and has reporting capability based on specific reporting requirements from geographic or jurisdictional authorities or other requirements. Since this system implements the mechanism of hand-washing with a hardware implementation, any attempt to monitor arbitrarily complex hand-washing in this system may require complete redesign of the hardware system.

Lacey, et al in U.S. Pat. No. 8,090,155 (Jan. 3, 2012) discloses a system which monitors a hand-washing station by way of a camera aimed at a sink. The camera is connected to a computing system so that images may be collected of a user's hand-washing. The images can be analyzed to determine whether the user's hands performed a predetermined sequence of motions. In addition, the system can “learn” through iterative adaptation, what hands and hand-washing motions look like. However, the system does not learn what an individual user's hands look like or what the hand-washing motions of an individual user look like.

This system goes further than Glenn et al in that it can more easily be adapted to a higher level of complexity thru training or programmatic changes. However, it is still limited in the ability to monitor arbitrarily complex sequences of hand-washing motions which may be either not visible to, or not distinguishable to, a single camera. For example, the requirement to wash arms up to the elbows may put the action being monitored out of view of the camera. Lacey et al is further limited by the fact that while a user is monitored and may receive a report from time to time, there is no immediate correctional feedback. Clearly, it is not sufficient for a surgeon to go into surgery with inadequate hand-washing that may be reported to him or a regulatory authority later. It would be better if the surgeon received immediate correction to insure proper hand washing and if a report could be immediately issued to management in the event of a failure of compliance.

This invention expands the scope of hand-washing monitoring to allow monitoring of arbitrarily complex hygiene activities as well as incorporating immediate feedback and management reporting. In operation the system is effectively equivalent to having a hand-washing coach standing in front of a user, observing and coaching them through a prescribed process. The prescribed process may vary based on the user's job, specific tasks that have been performed or will be performed.

### SUMMARY

The present invention describes a hand-washing monitoring system capable of monitoring arbitrarily complex user specific hygiene activity. It provides immediate instruction, feedback, correction and reporting.

In each of the various embodiments, a user approaches a hand-washing station and is identified through RFID or through any one of a number of possible biometric methods (speech recognition, face recognition, etc.). Once the system identifies the user, it retrieves user-specific information including, but not limited to, which specific hand-washing protocol the user must complete, instructional information to be provided to the user about the protocol, and in some embodiments user-specific entertainment content and verbal commands the user may issue to the system to modify execution of the protocol, etc.

The system then begins to instruct the user in the protocol and the user begins execution of the protocol. The system continues to instruct the user in each of the separate steps or subsections of the protocol and each such step or subsection is monitored by the system for compliance. When non-compliance is detected the user may be asked to redo a step or may be asked to take other corrective action including stopping the protocol, performing another activity and trying again later. The system may issue immediate alerts to management in the event of a protocol violation.

Data collected by the system includes the identity of the user, the date, time and location of the washing event, degree of compliance with each step in the protocol as well as compliance with the complete protocol, user response to any requests for re-performing any part of the protocol and/or any corrective action recommended. Data may include any video images of the washing event captured by the system and/or any audio collected from the user. All data is saved to storage media in a computing system for management review and reporting.

### BRIEF DESCRIPTION OF THE DRAWINGS

FIG. 1 shows a person using a typical embodiment of the system.

FIG. 2 shows typical computer network architecture of a system monitoring multiple wash stations

FIGS. 3 through 5 show a high level abstract process flow for a typical embodiment of the system.

### DETAILED DESCRIPTION

The following description discloses methods and systems for monitoring arbitrarily complex user- and context-specific hand-washing protocols and processes, providing instruction and immediate feedback to the user about their compliance with said protocols and storage of information about all hand-washing events and compliance therewith for management review and reporting.

In this detailed description, reference is made to the associated drawings of the system and are not to be construed as limiting the invention or any part thereof to any particular embodiment described.

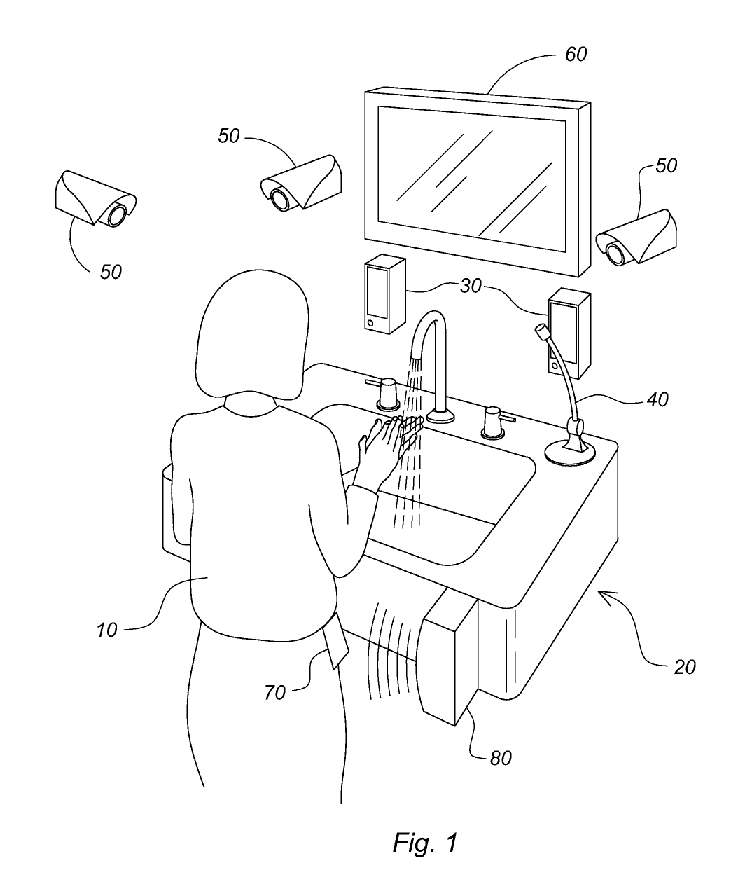

FIG. 1 shows a person using a typical embodiment of the system. The user (10) stands at a sink or wash station (20). Upon approach to the wash station the user is identified by either an RFID reader (80) reading the user's RFID badge (70), a camera (50) capturing an image of the user's face and sending it to a computer for face recognition identification, the user speaking into a microphone (40) which captures the user's utterance of a unique phrase which is sent to a computer for speech recognition identification of the user, or the like. Instructional or entertainment content retrieved by the system for the user is then displayed on a video monitor (60) with audio being played through a speaker (30). As the user proceeds to comply with instruction for a hand-washing protocol, additional cameras (50) are oriented so as to capture images of any motions appropriate to the protocol. Said images are immediately analyzed for compliance and interactive feedback and additional instructions are provided to the user until the protocol is either complete or aborted. The user may speak commands to the system via the microphone (40) which may alter the flow of the protocol, so the system is truly interactive.

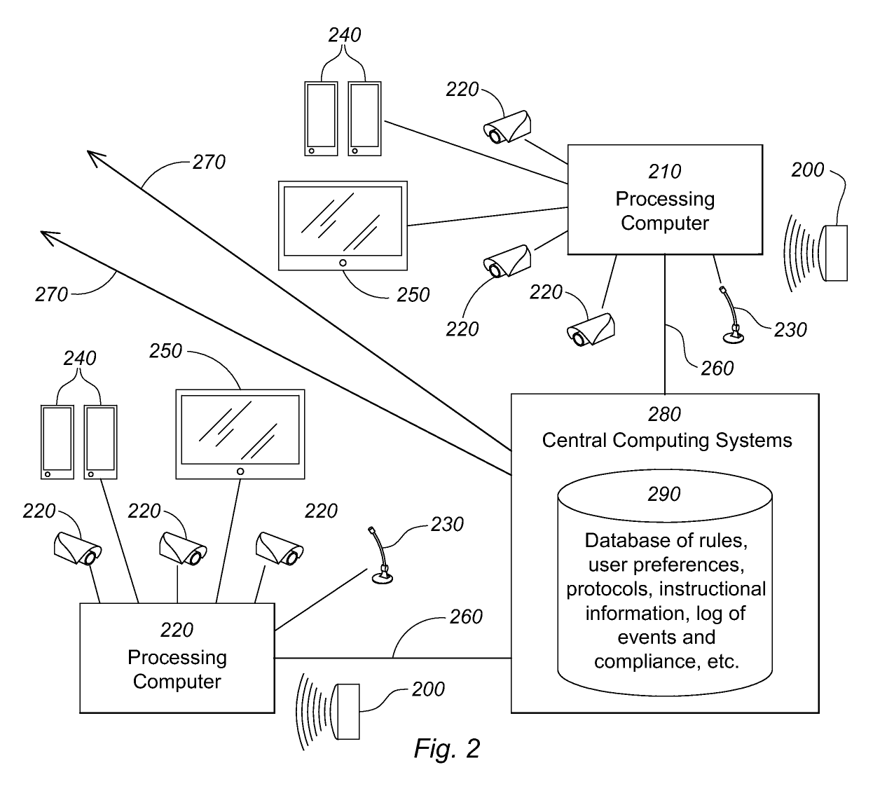

FIG. 2 shows typical computer network architecture of a system monitoring multiple wash stations. It will be understood that in a facility such as a hospital, management may require monitoring of a large number of hand-washing station that have somewhat different protocols, and that data must be collected and analyzed from all monitors by a single computing system. Therefore a typical embodiment would entail a central computer system or a set of computers (280) that share the work of processing information received from the various monitoring stations (210). Said computers being connected via a network to a computing system at each monitoring station which does the work of processing any data with respect to the hand-washing that must be monitored in proximity to the wash station. Connections to two such monitoring station computers (210) are shown (260) and connections to other stations may be present (270). The computer at each wash station is connected to any peripheral hardware being used at the monitoring station—LCD monitor (250), cameras (220), speaker (240), microphone (230), RFID reader (200) and the like. In addition to logging all monitored events, the central computing system (280) is a repository of information about specific protocols that may be required of users, specific user parameters, such as information about what a user's hands look like, how a specific user performs the motions required by specific steps in a protocol, user selected entertainment content, etc. (290).

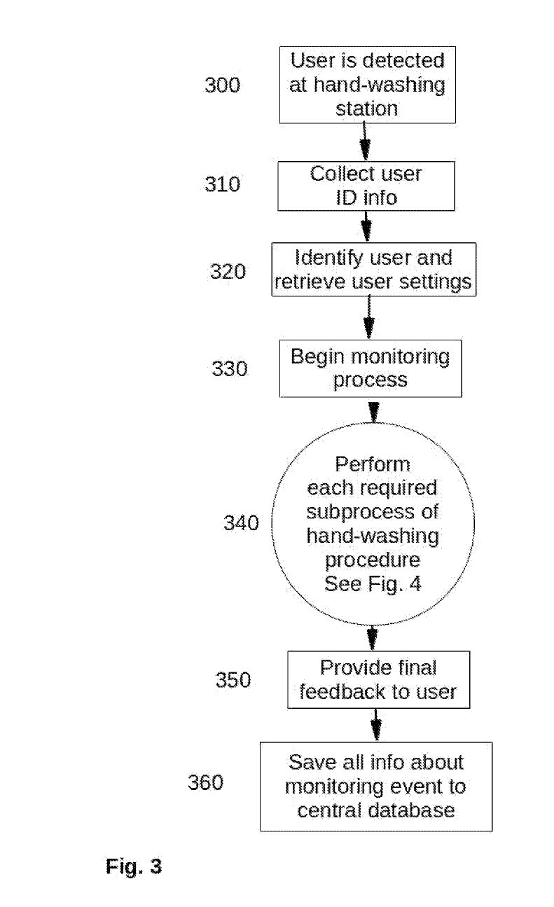

FIGS. 3 through 5 show a typical process flow for an embodiment of the system. In FIG. 3, a user is detected at a wash station (300). The system collects the user's ID information (310). The user is identified by the system and user-specific information is retrieved (320). Based on the user-specific information, the wash station location, etc, a protocol is selected and monitoring of compliance with the protocol is initiated (330). Compliance with each step or subprocess in the selected protocol is monitored (340) and feedback is provided to the user (350). Finally, all data about the washing event is saved to the central database (360).

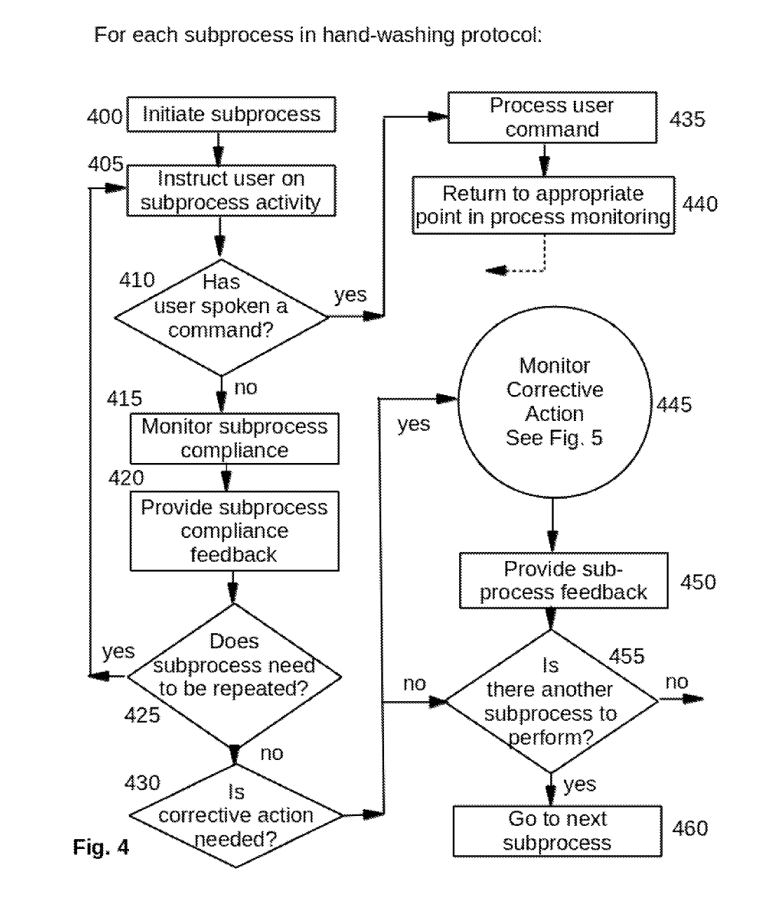

FIG. 4 shows the compliance monitoring for each step or subprocess of a specific protocol. The subprocess is initiated (400) by instructing the user on how to perform the step (405). If the user has issued a command to the system (410), the system processes the user's command (435). For example, this may be a command to skip this subprocess, or to perform one of a number of options for the subprocess based on system and user-specific setup. After processing the user's command, the system returns to the appropriate place in processing either the subprocess or the complete hand-washing monitoring protocol (440). If there is no user command to process, the system proceeds to monitor compliance with the subprocess (415). The system then provides immediate feedback to the user on their performance of the subprocess (420). For subprocesses of a certain intrinsic complexity, it will be understood that the system may iteratively provide instruction and feedback during the monitoring process. It will also be understood that the complete protocol may be broken down into subprocesses of sufficient simplicity that instruction, monitoring and feedback are completed in a single pass. After monitoring of the user's performance of the subprocess, the system determines whether the performance was sufficiently substandard that the process needs to be repeated (425). If so, the subprocess is repeated. If not, the system determines whether the performance was marginal, but some other corrective action is needed (430). If corrective action is needed, the system will monitor the corrective action (445) and provide the final subprocess feedback to the user (450). If there is another subprocess to be monitored (455), the system will then begin execution of that subprocess (460); otherwise it will return to the main protocol monitoring process.

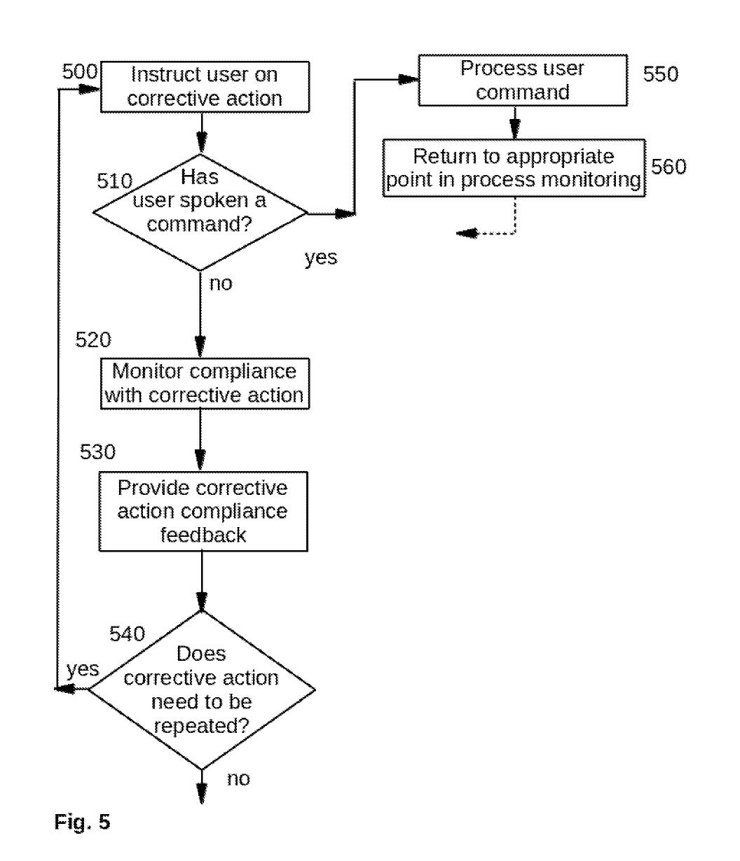

FIG. 5 shows compliance monitoring for any corrective action that is required with a protocol subprocess to correct an action that is not adequately performed. The user is instructed on how to perform the corrective action (500). As described previously, at any time that they user issues a command to the system (510), the system processes the command (550) and returns to the appropriate point in the protocol monitoring process (560). Otherwise, the system monitors performance of the corrective action (520), provides appropriate feedback to the user (530) and determines whether the particular corrective action needs to be repeated (540).

In one embodiment of the system, a surgeon walks into the pre-surgical scrub area to thoroughly wash his hands and forearms before he enters the surgery room. He steps up to the sink. On the wall is a video screen.

A camera is embedded above, near the screen, or perhaps even behind a semi-transparent screen. The camera captures his image and sends it to a server where a face recognition algorithm running on the server identifies the surgeon.

The image of a hand-washing coach appears on the screen and greets the surgeon by name. The computer system displaying the hand-washing coach has data on all scheduled surgeries for the day, and so, knows the surgeon is likely there to perform a per-surgical scrub. The virtual hand-washing coach says “Are you ready to begin a surgical scrub?” The surgeon answers may answer “Yes” or “No”. If the surgeon answers “No”, the hand-washing coach will says “Please let me know when you are ready.” and then wait until the surgeon says “Ready”.

When the surgeon says “Yes” or “Ready”, the hand-washing coach will say “Let's begin”.

Two cameras are mounted with their lines of site at 90° to each other on either side of the video screen. Using images from these cameras processed to extract 3D information, the virtual hand-washing coach will determine whether the surgeon has complied with a checklist of pre-scrub activities based on rules stored in a central computer, such as making sure the surgeon is appropriately dressed, sleeves are rolled up, skin on hands and forearms is not broken, fingernails are appropriate length, no jewelry is present, surgeon has assumed proper posture, etc. For each item on this pre-scrub checklist, the virtual hand-washing coach may request that the surgeon rectify any problems found and wait until the surgeon does so or indicates they have done so before re-inspecting that item.

The virtual hand-washing coach will then walk the surgeon through the series of steps necessary for a full surgical scrub, such as those shown in http://www.youtube.com/watch?v=O1sS0ahb4MA). The series of steps will be based on a rule set or protocol stored in a central computer system that corresponds to the type of hand-washing process being performed (in this example, a full surgical scrub) and the level of expertise and hand-washing compliance history of the user. At each step in the hand-washing process, images from the multiple cameras will be combined and processed in such a way as to determine the level of compliance with the rule or protocol for that step. The user will be informed by the virtual hand-washing coach verbally and/or on the video monitor of the level of compliance achieved and may be asked to repeat the step if the level of compliance is not satisfactory. The user may also choose to ask the system to skip or repeat a step. The system is completely interactive and may fork or loop back depending on the level of compliance and system/user interaction at each step.

The results of the analysis of each step in all processes is recorded in a central database, including the level or quality of compliance with the step, any steps skipped or repeated, identity of the user, date, time and location of the hand-washing events and is made available to management in a variety of reporting options.

In another embodiment of the system, an employee of a food handling facility walks up to the sink in a publicly accessible restroom. The employee identifies themselves to the system by speaking a unique phrase. A speech recognition algorithm running on the central server either identifies the user.

The image of a person, selected by the employee from a set of possible persons, appears on a video monitor mounted inside the mirror over the sink. The video monitor is behind a two-way mirror so that when it is not illuminated the mirror looks like a mirror, but when the monitor is activated, it is visible through the mirror.

The person on the monitor walks the user through the steps of a basic hand-washing per a rule set stored in a central computer. Two cameras are mounted one on either side of the sink. The cameras may be oriented and/or programmed so that they can only “see” the area in which hand-washing would occur and not the rest of the restroom, thus creating a “zone of privacy” outside the view of the cameras. For example, consider just the area immediately in front of a sink in a ladies lavatory. First, one would define the area such as a space of 4′×5′×8′, centered on the sink. The area is 5 feet deep, starting at the mirror and ending 5 feet back from the mirror and eight feet tall, from the floor up. Each point within this box may be identified by x, y, and z coordinates (abscissa, ordinate and applicate). The cameras are then programmed to look at those points only. All points outside this space would be outside the field of vision of the cameras. They would be effectively turned off. Someone standing six feet hack from the mirror would not be seen. As they inched forward, when their nose passed the rear plane, just the nose would appear. Next, the eyebrows would appear, then the front of the face, then the ears, etc. as they moved further into the visible zone.

Images from the cameras are sent to a central computer during the hand-washing and combined and processed so that the system can determine, for each step of the hand-washing process, the degree of compliance of the user, based on a rule set about how and how well each step is to be performed.

As in the previous embodiment, the system is fully interactive. The instructional image may tell the user to repeat a step and may provide feedback on the user's current or overall historical compliance score. As in the previous embodiment the date, time and location of the hand-washing, identity of the user and all data pertinent to the level of compliance with all steps in the hand-washing process are saved to a central computer and made available to management in a variety of reports.

It will be clear that various changes may be made to the processes, computing systems, specific methods of user identification and interaction, and other methods described in the various example embodiments presented here without departing from the scope of this invention.

What is claimed:

1. A system for monitoring an arbitrarily complex hand-washing process or any part thereof, comprising:
a computing device connected to one or more of:
a user ID subsystem,
a set of two or more hand-washing monitoring cameras mounted in proximity to a sink and oriented
so as to view all hand and/or arm motions of a user performing said set of hand-washing motions
and further oriented so as to allow the computing system to reconstruct sequences of three dimensional images of the hand and/or arm motions from the composited camera images,
a video monitor positioned so as to be visible to the user,
one or more speakers positioned so that audio emitted from the speakers is audible to the user;
said computing device containing an algorithm for identifying a user based on input from the user ID
subsystem;
said computing device providing audio and/or video instructions to the user on how to perform each
step of said processes;
said computing device containing an algorithm for analyzing images from said set of hand-washing monitoring cameras and making a determination whether the user has satisfactorily performed each
step of said processes;
said computing device informing the user via audio and/or video feedback if any step or series of steps of said processes has not been performed satisfactorily, determining appropriate possible actions for the user to take based on a set of rules about the degree of compliance required for a particular step or series of steps and requesting that the user select from among those possible actions
and perform the selected action.

2. The system of claim 1, further comprising:
a microphone positioned so as to detect speech from the user;
said computing device containing an algorithm for analyzing a user's speech recorded by said microphone, to determine if user has issued a known command to the system, and for responding to
any such commands.

3. The system of claim 1 wherein the user ID system is a microphone and said computing device contains an algorithm for identifying a user by speech recognition or voice ID based on audio recorded by said microphone.

4. The system of claim 1 wherein the user ID system is a single camera mounted in proximity to a sink and directed so as to view the face of a user performing the hand-washing processes and said computing device contains an algorithm for identifying a user by face recognition based on video recorded from said camera.

5. The system of claim 1 wherein the user ID system is an RFID badge reader mounted in proximity to a hand-washing sink and said computing device contains an algorithm for identifying the user based on information read from the user's RFID badge.

6. The systems of claims 1, wherein said system further comprises a microphone positioned so as to detect speech from the user and said computing device contains an algorithm for analyzing a user's speech recorded by said microphone, to determine if the user has issued a known command to the system, and for responding to any such command, said computing device further contains databases for logging data from each hand-washing process event including but not limited to any subset of the following:
location of the hand-washing event;
identity of the user performing the hand-washing processes;
date and time of the beginning and end of the full hand-washing processes performed or any parts thereof;
any specific steps in the hand-washing process which were not satisfactorily performed by the user and the reason said step was not satisfactorily performed and user's action in response to being informed of non-satisfactory performance of said step;
a video recording of a hand-washing process or any part thereof;
a video image of a user;
audio recordings of any audio spoken by the user during a hand-washing process including audio spoken for user identification, audio commands spoken to the system and/or audio responses spoken
by user in response to system instructions or information.

7. The system of claim 6, wherein said computing device is able to run a program to allow management of users performing hand-washing processes to view any detailed information regarding the hand-washing processes contained in the computing device database.

8. The system of claim 6, wherein said computing device provides immediate alerts to management when a user has not satisfactorily performed a hand-washing process or any part thereof.

9. The system of claim 6, wherein, in response to spoken commands by the user or based on user-specific system setup parameters, the monitor displays educational or entertainment video to the user during the hand-washing processes instead of video hand-washing instructions.

10. The system of claim 6, wherein, in response to spoken commands by the user or based on user-specific system setup parameters, the system plays musical content specific to the identified user, during the hand-washing process instead of spoken hand-washing instructions.

11. The system of claim 1, wherein, said computing device is able to run a program which, by repeated analysis of an individual user's hand-washing motion, the system learns what the individual's hand-washing motions look like so that the system can more accurately determine whether the specific user's hand-washing motions are in compliance with system protocols when monitoring a hand-washing event for the user.

12. The system of claim 1, wherein said computing device is able to run a program to train or program the system to know what an individual user's hands look like so that the system can more accurately determine whether the specific user's hand-washing motions are in compliance with system protocols when monitoring a hand-washing event for the user.

13. The system of claim 1, wherein the cameras oriented toward the user's hands are mounted, oriented and instructed or programmed to view only a particular spatial region of interest, creating a zone of privacy which the cameras cannot see and a zone of visibility which the cameras can see.

14. The system of claim 1, wherein the instruction or communication to the user by the computer system via a video display is replaced with communication via a holographic projection.

15. The system of claim 1, wherein the user can select a particular voice to perform the audio hand-washing instruction from a standard group of voices or can download voice files to pick a unique personalized voice to perform the audio hand-washing instruction.

16. The system of claim 1, wherein the user can select the image of a particular person to perform the video hand-washing instruction from a standard group of images of persons or can download image files to pick a unique personalized image of a person to perform the video hand-washing instruction.

17. The system of claim 1, wherein said computing device contains a database that allows management to set up rules about the degree of compliance necessary for each step or series of steps in the hand-washing process, what user actions are appropriate in response to each degree of non-compliance, how the system will instruct the user and/or log the degree of compliance with said rule and what level of instruction the system will provide based on the level of expertise of the user.

18. The system of claim 14, wherein the holographic display may rotate or zoom the instructional images to better show the instructions for the step being performed, based on system monitoring of the current or historical performance of said step by the user.
